(19) United States
(12) Patent Application Publication
(10) Pub. No.: US 2009/0317764 A1
(43) Pub. Date: Dec. 24, 2009

(54) Endosteal Dental Implant

(76) Inventors: Graham Alan Blackbeard, Centurion (ZA); Martin MacAllister, Belfast (IE)

Correspondence Address: MARSHALL & MELHORN, LLC, FOUR SEAGATE - EIGHTH FLOOR, TOLEDO, OH, 43604, US

(21) Appl. No.: 11/988,411

(22) PCT Filed: Jul. 12, 2006
(86) PCT No.: PCT/IB2006/001919

§ 371 Date: Apr. 23, 2009

(30) Foreign Application Priority Data
Jul. 15, 2005 (ZA) 2005/5699

(51) Int. Cl. A61C 8/00

(52) U.S. Cl. 433/174

(57) ABSTRACT

One aspect of the invention concerns a one-piece endosteal dental implant (10). The implant (10) has a root portion (12) which is externally threaded for engagement in a hole formed in a supporting bone structure. The implant also has an abutment (14) for supporting a dental prosthesis. The abutment is formed in one piece with the root portion and has a central axis (22) which is inclined at an acute angle to the central axis (20) of the root portion. The abutment includes a formation (26) which can be engaged by an implant driving tool (28) operable to engage the root portion in the supporting bone structure. Other aspects of the invention concern a dental implantation apparatus that includes the dental implant and driving tool in combination and the driving tool itself.

### BACKGROUND TO THE INVENTION

THIS invention relates to an endosteal dental implant.

Dental implants are traditionally of one or two piece construction. The present invention is specifically concerned with one-piece dental implants.

A conventional one-piece dental implant has a root portion which is implanted in the bone structure of the jaw and an abutment or crown portion which will project beyond the gum over the bone to provide an anchor or foundation for the dental prosthesis itself.

Conventionally, the root and crown portions are axially aligned with one another. Such arrangements are geometrically correct for teeth which are naturally oriented in alignment with the supporting bone structure of the jaw. However such known one-piece implants are not ideal in the case of teeth, such as upper and lower incisors, which grow naturally at an angle to the supporting bone structure of the jaw because the tooth prosthesis cannot then be centralised on the abutment if it is to have the correct orientation in the mouth.

### SUMMARY OF THE INVENTION

According to one aspect of the invention there is provided a one-piece endosteal dental implant comprising:
an elongate root portion at least partially externally threaded for engagement in a hole formed in a supporting bone structure, the root portion having a central axis; and
an abutment for supporting a dental prosthesis, the abutment being formed in one piece with the root portion and having a central axis inclined at an acute angle to the central axis of the root portion, and the abutment including a formation engagable by an implant driving tool operable to engage the root portion in the supporting bone structure.

The root portion of the preferred embodiment has an externally threaded inner end region, typically tapered, and a cylindrical region, adjacent the end region, from which the abutment extends.

In the preferred embodiment, the acute angle of inclination between the axes of the abutment and root portion is approximately 8°, the abutment is of tapered, frustoconical shape and the abutment has a socket, typically hexagonal in cross-section, in an end thereof remote from the root portion, which is engagable by the driving tool

According to another aspect of the invention there is provided a dental implantation apparatus comprising a dental implant as summarised above and a driving tool which includes an elongate stem having a central axis and a formation, carried by one end of the stem, for engaging the abutment of the dental implant, the formation being laterally off-set relative to the central axis of the stem and itself having a central axis which is inclined at an acute angle relative to central axis of the stem.

Preferably the acute angle at which the central axis of the abutment engaging formation of the driving tool is inclined relative to the central axis of the stem of the tool is the same as the acute angle at which the central axis of the abutment of the dental implant is inclined relative to the central axis of the root portion of the dental implant.

Yet another aspect of the invention relates to the driving tool itself.

Other features of the invention are described below and are set forth in the appended claims.

### BRIEF DESCRIPTION OF THE DRAWINGS

The invention will now be described in more detail, by way of example only, with reference to the accompanying drawings in which:

FIG. 1 shows a side view of a dental implant according to this invention;

FIG. 2 shows a cross-section at the line 2-2 in FIG. 1;

FIG. 3 shows a side view of an implant driving tool according to the invention;

FIG. 4 shows a cross-section at the line 4-4 in FIG. 3; and

FIG. 5 shows a cross-section at the line 5-5 in FIG. 3.

### SPECIFIC DESCRIPTION

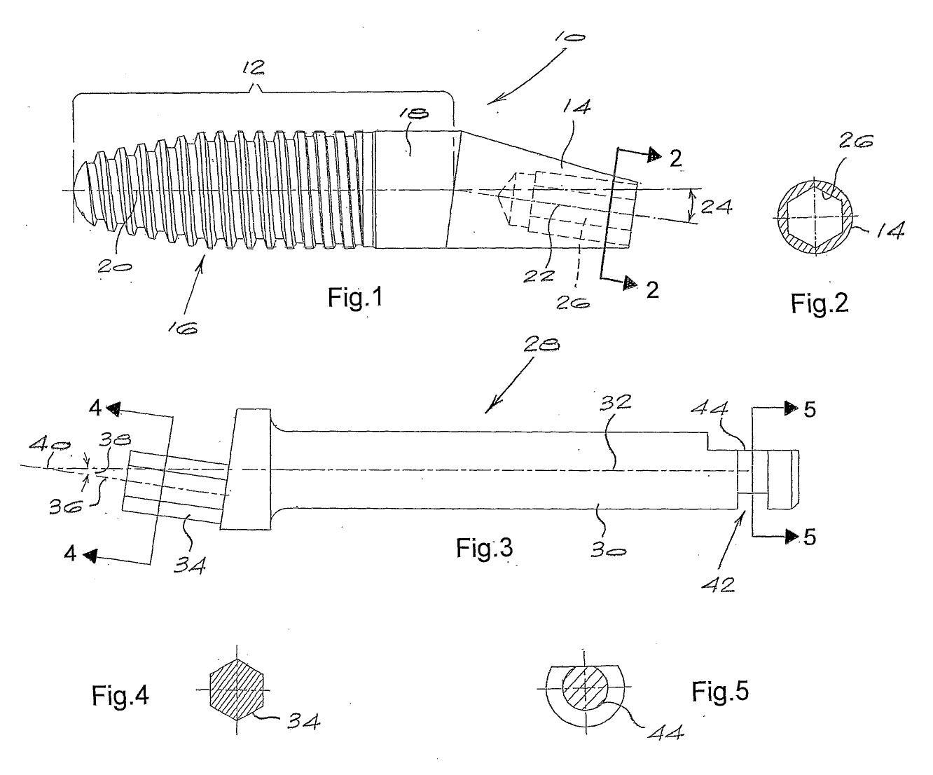

The dental implant 10 seen in FIG. 1 is machined in one piece of grade 4 titanium and includes an elongate root portion 12 and an integral abutment or crown portion 14. The root portion has an externally threaded, tapered inner end region 16 which is surface-roughened and a round cylindrical region 18 from which the abutment 14 extends. The central axis of the root portion 12 is indicated by the reference numeral 20.

The abutment 14 has a frustoconical shape and a central axis 22 which intersects the axis 20. The axis 22 is orientated at an acute angle 24 of 8° relative to the axis 22.

At its end remote from the root portion, the abutment is formed with a countersink which is in the form of a hexagonal section socket 26 over the major part of its length. In use, the end region 16 of the root portion is engaged by a screwing action in a hole drilled in a supporting bone structure. After normal osseointegration of the root portion, the abutment stands proud of the bone structure to provide an anchor or foundation for a prosthetic tooth. Persons skilled in the art will be familiar with the orthodontic procedures involved in these steps.

The illustrated implant is particularly suited for use in implantation of teeth which are naturally oriented at an angle to the supporting jaw bone, for instance the upper and lower incisors which are, in a normal mouth, inclined slightly rearwardly relative to the maxillar and mandibular bone structures. It will be understood that in such applications, the root portion is rotated on installation to an orientation consistent with the eventual, desired orientation of the prosthesis, allowing the prosthesis to be substantially centralised on the abutment.

It will also be understood that the angle 24 can be varied for implantation of different teeth. Other dimensions, for instance the length of the root portion, may also be varied to suit different tooth positions and jaws.

The socket 26 serves as an engagement formation for an implant driving tool which is used to install the implant 10. A preferred driving or installation tool 28 is illustrated in FIGS. 3 to 5 of the drawings. The tool 28 has an elongate round cross-section stem 30 having a central axis 32 and carrying an engagement formation 34 having a central axis 36. The formation 34 is off-set laterally relative to the axis 32, and the axis 36 is inclined relative to the axis 32 by an angle 38 of 8°, i.e. the angle 38 is same as the angle 24.

It will be understood that the formation 34 is engagable in the socket 26 and that rotation of the stem will rotate the implant 10 for the purposes of screwing it into the bone. It will furthermore be understood that the off-set and inclination of the formation 34 results in precession of the stem about the point 40 at which the axis 34 intersects the axis 32 when rotated.

The end 42 of the stem is shaped with a flat 44 to facilitate gripping and rotation thereof.

1-14. (canceled)

15. A one-piece endosteal dental implant comprising:
an elongate root portion at least partially externally threaded for engagement in a hole formed in a supporting bone structure, the root portion having a central axis; and
an abutment for supporting a dental prosthesis, the abutment being formed in one piece with the root portion and having a central axis inclined at an acute angle to the central axis of the root portion, and the abutment including a formation engagable by an implant driving tool operable to engage the root portion in the supporting bone structure.

16. The dental implant according to claim 15 wherein the root portion has an externally threaded inner end region and a cylindrical region, adjacent the end region, from which the abutment extends.

17. The dental implant according to claim 16 wherein the inner end region of the root portion is tapered.

18. The dental implant according to claim 15 wherein the acute angle of inclination between the axes of the abutment and root portion is approximately 8°.

19. The dental implant according to claim 15 wherein the abutment is of tapered, frustoconical shape.

20. The dental implant according to claim 19 wherein the abutment has a socket, in an end thereof remote from the root portion, which is engagable by the driving tool.

21. The dental implant according to claim 20 wherein the socket has a hexagonal cross-section.

22. A dental implantation apparatus comprising a dental implant according to claim 15 and a driving tool which includes an elongate stem having a central axis and a formation, carried by one end of the stem, for engaging the abutment of the dental implant, the formation being laterally off-set relative to the central axis of the stem and itself having a central axis which is inclined at an acute angle relative to central axis of the stem.

23. The dental implantation apparatus according to claim 22 wherein the acute angle at which the central axis of the abutment engaging formation of the driving tool is inclined relative to the central axis of the stem of the tool is the same as the acute angle at which the central axis of the abutment of the dental implant is inclined relative to the central axis of the root portion of the dental implant.

24. The dental implantation apparatus according to claim 22 wherein the abutment engaging formation of the driving tool is hexagonal in cross-section.

25. The dental implantation apparatus according to claim 24 wherein an end of the stem of the driving tool, remote from the abutment engaging formation of the driving tool, is formed with a flat.

26. A driving tool for a dental implant according to claim 15, the tool including an elongate stem having a central axis and a formation, carried by one end of the stem, for engaging the abutment of the dental implant, the formation being laterally off-set relative to the central axis of the stem and itself having a central axis which is inclined at an acute angle relative to central axis of the stem.

27. The driving tool according to claim 26 wherein the central axis of the abutment engaging formation is inclined at an angle of approximately 8° relative to the central axis of the stem.

28. The driving tool according to claim 26 wherein an end of the stem remote from the abutment engaging formation is formed with a flat.
